(19) United States
(12) Patent Application Publication
(10) Pub. No.: US 2007/0139002 A1
(43) Pub. Date: Jun. 21, 2007

(54) Battery charger for a personal electronic device

(76) Inventors: Mo-Lin Chao, Tamshui (TW); Ching-Cheng Kao, Tamshui (TW)

Correspondence Address: TROXELL LAW OFFICE PLLC, SUITE 1404, 5205 LEESBURG PIKE, FALLS CHURCH, VA, 22041, US

(21) Appl. No.: 11/484,658

(22) Filed: Jul. 12, 2006

(30) Foreign Application Priority Data
Dec. 16, 2005 (TW) 094221982

(51) Int. Cl. H02J 7/00

(52) U.S. Cl. 320/112

(57) ABSTRACT

A battery charger for a personal electronic device comprising: a housing, a battery energy storage unit, a battery charging circuit, an electric power converting circuit, at least one power input portion and at least one power output portion. The at least one power input portion includes a plug or socket for connecting to a socket of A.C. source, and a D.C. socket that can be connected to a computer through a USB interface for charging the battery charger. The power output portion has an interface able to connect to a mobile phone or electronic device for charging the latter. The power output portion can also design as a socket, and disposited at the same position on the housing with the D.C. socket of power input portion. The battery charger can be connected to a personal miniature electronic device, such as a mobile phone, a digital camera or an MP3 player, for charging the device by using the battery energy storage unit as an energy source.

### BACKGROUND OF THE INVENTION

1. Field of the Invention

The present invention relates to a battery charger for a personal electronic device, and especially to an electric charger which can store energy, can charge a personal electronic device when there is no other electric power source, and suits a traveler to use.

2. Description of the Prior Art

Nowadays, mobile phones, digital cameras etc. have become daily used electronic devices. The power of the batteries of these electronic devices decides time's length of use of the electronic devices. Electronic devices such as mobile phones, digital cameras etc. must be used with corresponding battery chargers. Generally, these battery chargers (or called as power supplies) are unique to the corresponding electronic devices; they are sent as gifts accompanied with the electronic devices.

In the past time, if the battery of an electronic device is to be charged, it uses a conventional battery charger as shown in FIG. 1. The battery charger 2 shown in FIG. 1 includes an AC/DC converter 10 and a charging seat 21; the AC/DC converter 10 is provided with a plug 11 which protrudes from the AC/DC converter 10 for taking an alternative electric power source. In using, a battery 22 to be charged of the electronic device must be removed and placed on a charging recess of the charging seat, and then it can be charged. However, a battery 22 of a conventional electronic device generally can only be charged through an AC electric power source such as 110V or 220V.

Users nowadays will carry many miniature electronic devices when they go outside, for instance, they carry two mobile phones of different types, a digital camera and an MP3 player. Although each miniature electronic device has a spare battery and a specific battery charger, too many spare batteries and battery chargers make inconvenience of the user in carrying them.

Thereby, a battery charger with chemical energy has been developed in the markets (not shown); the battery charger generates energy by the chemical reaction of its own to charge the battery of an electronic device. However, such a battery charger with energy generated by the chemical reaction normally is discarded after use, it is unable to be recharged, cost high and is subjected to polluting environment.

From the above stated, we can find that: in battery charging, a battery charger that can be used to repeatedly charge a battery of an electronic device generally is connected to a socket of A.C. (alternating current) source. This is inconvenient for those who are unable to use A.C. source. And more, as was stated above, too many spare batteries make inconvenience of the user in carrying them.

Accordingly, the present invention is to solve the problem of inadequacy of conventional devices and to provide a battery charger of a personal electronic device.

### SUMMARY OF THE INVENTION

An objective of the present invention is to provide a battery charger for a personal electronic device that can charge chargeable batteries for various personal miniature electronic devices (such as a mobile phone, a digital camera or an MP3 player) without an external power source.

Another objective of the present invention is to provide a battery charger for a personal electronic device which can be charged by A.C. or D.C. source and repeatedly used.

A further objective of the present invention is to provide a battery charger for a personal electronic device which is provided with a key ring on its housing, its shape is designed as a pet or a pendant, and suitable for personal carrying.

In order to achieve the above stated objectives, the battery charger for a personal electronic device of the present invention comprises: a housing, a battery energy storage unit, a battery charging circuit, an electric power converting circuit, at least one power input portion and at least one electric power output portion. The battery energy storage unit, the electric power converting circuit and the battery charging circuit are all provided inside the housing, the electric power input portion and the electric power output portion are provided on the housing.

A feature of the present invention is that: the power input portion includes a plug for connecting to A.C. source.

Another feature of the present invention is that: the power input portion includes a D.C. socket for connecting to a computer through a USB interface, or connecting to other D.C. sources through other interfaces.

Another feature of the present invention is that: the power output portion includes an interface of a conductor that can be stretchably received in the housing, for connecting to a mobile phone or other electronic device.

A further feature of the present invention is that: a power output portion is a first D.C. socket, a power input portion is a second D.C. socket, and the first D.C. socket and the second D.C. socket are positioned at a same hole on housing of the battery charger.

Another feature of the present invention is that: the housing has a key ring fixing seat, a kind of modeling of a pet or a pendant is provided to envelop the housing, and the housing can be loaded in or taking out from the modeling.

The other features and effect of the present invention could be further understood after reading the detailed description of the preferred embodiment hereinafter in reference to the accompanying drawings.

### BRIEF DESCRIPTION OF THE DRAWINGS

FIG. 1 is a perspective view of a conventional battery charger of an electronic device;

FIG. 2A is a perspective view showing a preferred embodiment of a battery charger of the present invention;

FIG. 2B is a perspective view showing another preferred embodiment of the battery charger of the present invention;

FIG. 3 is an example of circuit block diagram of the battery charger of the present invention;

FIG. 4 is an example of circuit diagram of the battery charger of the present invention; FIG. 5 is a schematic perspective view showing that a battery charger of the present invention charges a mobile phone by a connecting line;

FIG. 6 is a perspective view showing the battery charger of the present invention is enveloped by a decorative envelopment of a kind of modeling;

FIG. 7 is a perspective view showing another preferred embodiment of the battery charger of the present invention, and showing various connecting lines in use.

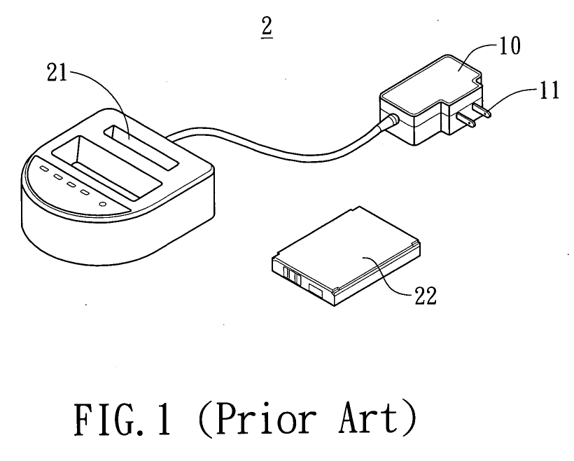

### DETAILED DESCRIPTION OF THE PREFERRED EMBODIMENT

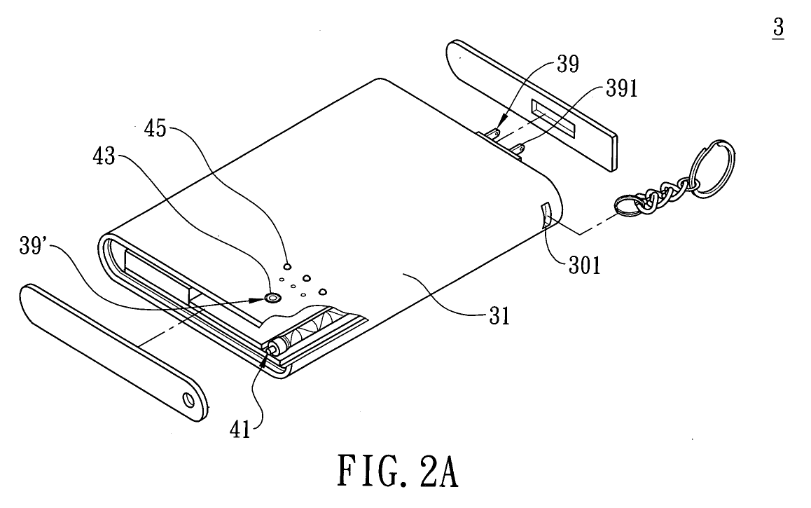

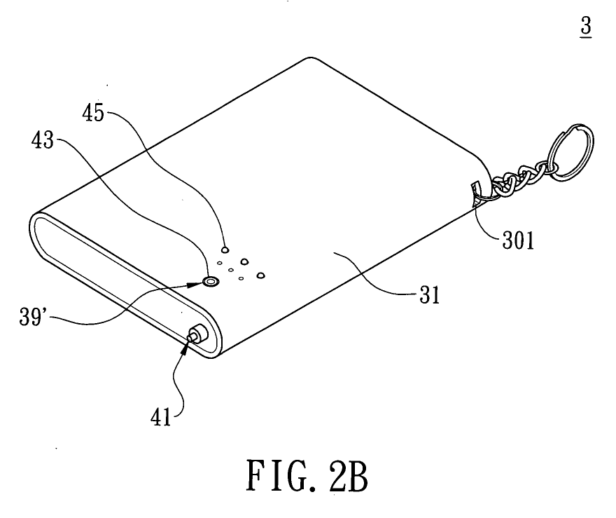

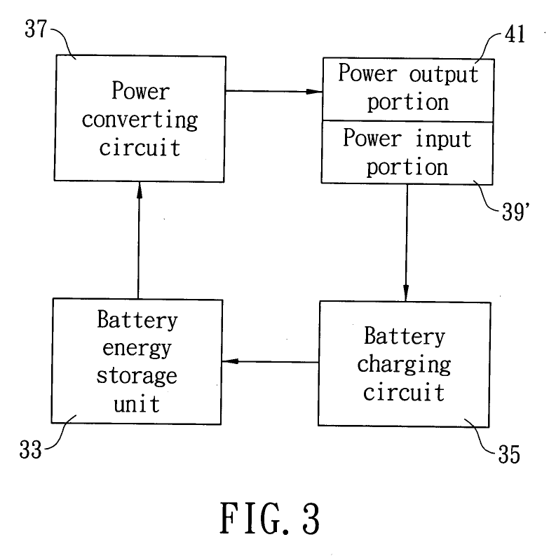

FIGS. 2A and 2B are perspective views showing the appearance of preferred embodiments of battery charger of an electronic device of the present invention. FIG. 3 is an example of circuit block diagram of the battery charger of the present invention. As shown in FIG. 2B and FIG. 3, a battery charger 3 of the present invention comprises: a housing 31, a battery energy storage unit 33, a battery charging circuit 35, an power converting circuit 37, an power input portion 39′ and an power output portion 41.

Another embodiment shown in FIG. 2A further includes an A.C. power input portion 39.

The housing 31 receives therein the battery energy storage unit 33, the battery charging circuit 35 and the electric power converting circuit 37; the power input portions 39, 39′ and the electric power output portion 41 are respectively provided on or in the housing 31.

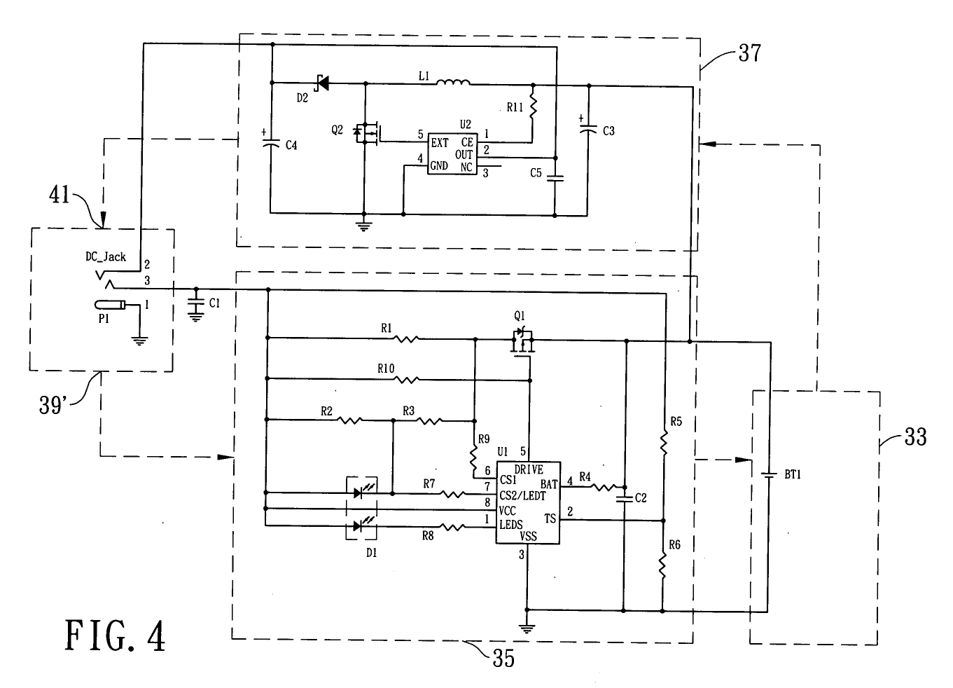

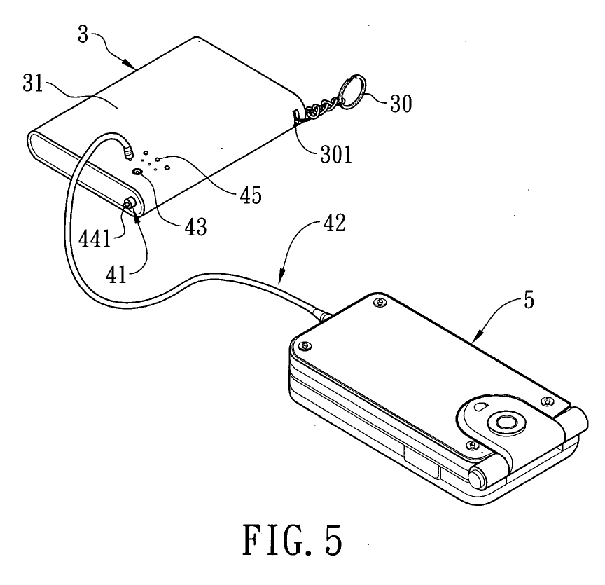

FIG. 4 is an example of circuit diagram of the battery charger 3 of the present invention; wherein the battery charging circuit 35 is electrically connected with the power input portion 39′ and the battery energy storage unit 33. The power converting circuit 37 is electrically connected with the battery energy storage unit 33 and the power output portion 41. Referring to FIG. 3, when an external power source inputs through the power input portion 39′, it can charge the battery energy storage unit 33 through the battery charging circuit 35. Thereafter, the battery energy storage unit 33 can charge a battery of a miniature electronic device through the electric power converting circuit 37 (i.e., a supercharging circuit) and through the power output portion 41 as a power source.

In the preferred embodiment of FIG. 2A, the power input portion 39 is an AC power plug (or socket) 391 for connecting to a socket of A.C. power source. In practicing, the plug 391 can be collapsed into the housing 31. The A.C. current can be transferred to D.C. current via a current rectifying circuit, and then be connected to the battery charging circuit 35, the battery energy storage unit 33 can be charged. The charging circuit of the present invention can be connected to an overcharging preventing circuit so that when the battery energy storage 33 is fully charged, the charging circuit can be automatically turned off, and prevent overheating.

In the embodiment of FIG. 2B, the embodiment does not include an AC electric power input portion 39, but use only an DC electric power input portion 39′ which is a DC socket in a hole 43 on the housing 31. A connecting line having a USB interface can be inserted into the D.C. socket to connect with a computer to take external D.C. power source to charge the battery energy storage unit 33.

In an environment having no external electric power source, the battery energy storage unit 33 of the battery charger 3 can be used as an power source to charge a battery of a personal electronic device. In an example of embodiment, a presently available mobile phone can accept the power of the battery energy storage unit 33 to use for further 20-30 hours.

Referring to FIG. 2A and FIG. 5, the electric power output portion 41 can be an interface 441 connected with a mobile phone, the interface 441 can be a conductor stretchably received in the housing 31.

The battery charger 3 further includes an indicating lamp 45 provided on the housing 31, and is electrically connected with the battery charging circuit 35 and/or the electric power converting circuit 37. When the battery charger 3 is charged by external power source, or the battery energy storage unit 33 is charging the battery of other personal electronic device, the indicating lamp 45 is turned on, on the contrary, it is turned off; this can express whether the battery charger 3 is in working.

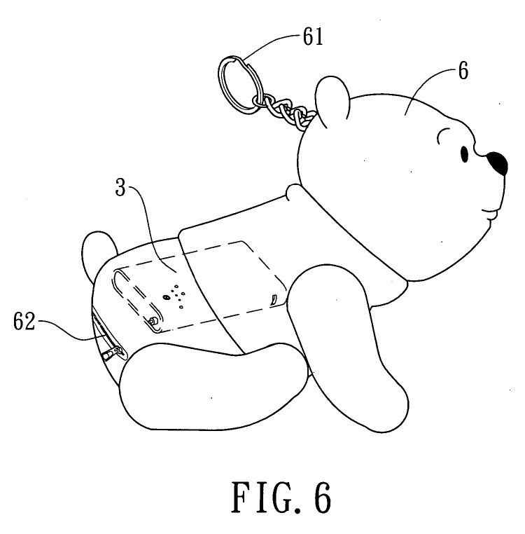

The housing 31 further is provided with a fixing seat 301 for a key ring 30, hence a user can conveniently carry the battery charger as a key ring 30. Besides, in order to decorate the contour of the housing 31, the housing 31 is enveloped by a decorative envelopment 6 with a kind of modeling. As is shown in FIG. 6, the decorative envelopment 6 with a kind of modeling can be in the form of a downy animal or a pet. The decorative envelopment 6 can similarly be provided with a key ring 61 (or hanging hook or the like), and the decorative envelopment 6 is provided with a sealing means that can open or seal an opening, for instance a zipper 62, a magic tape or the like, for taking or placing the battery charger 3 out/into the opening.

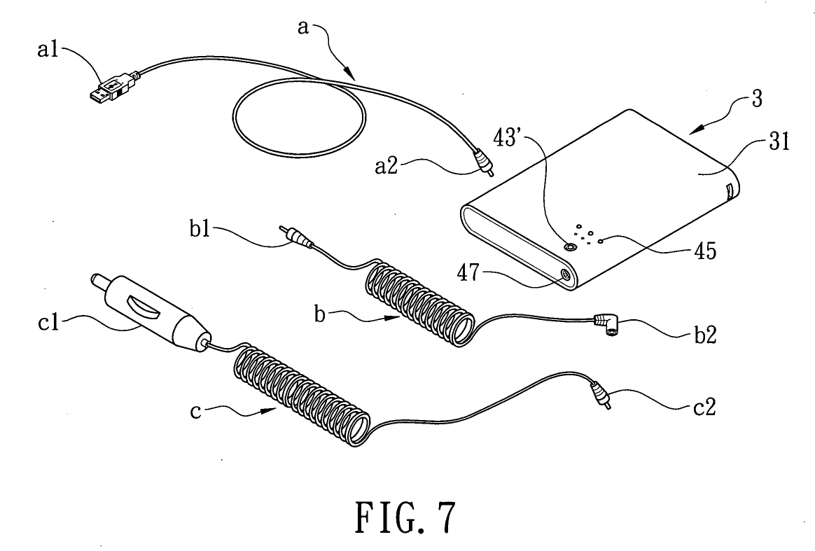

In another embodiment, referring to FIG. 7, at hole 43′, a first DC socket of power input portion is disposited there, and also a second D.C. socket of power output portion could be disposited therein. As stated above, through the first D.C. socket at hole 43′, a connecting line “a” having a USB terminal al can be used to connect a computer to take an external D.C. source, also a connecting line “c” having a plug c1 can be connected to a cigarette lighter's socket in cars to take power source of the car to charge the battery charger 3. Through the second D.C. socket at hole 43′, the battery charger 3 can also be connected to a miniature electronic device such as a mobile phone, a digital camera, an MP3 player etc. via a connecting line “b” with a socket b2 which is different with the connecting plugs a2, c2 of the connecting lines a and c. And more, the power output portion 41 in FIGS. 2A and 2B can be designed in a hole 47, and like in the hole 43′, a first D.C. socket of power input and a second D.C. socket of power output are disposited therein so that when through the hole 43′ (or 47) to take an external power source, it can simultaneously charge a miniature electronic device through another hole 47 (or 43′).

Accordingly, the present invention has the following advantages:
1. In addition to the function of a general battery charger for charging a miniature personal electronic device, the battery charger of the present invention provided with a battery energy storage unit can work in an environment that does not need connecting an external power source.
2. The charger of the present invention can have various embodiments, it can provide two power input portions including an AC power plug (or socket) and a DC socket, thereby it can be connected to A.C. power source or connected with a computer to get D.C. source.
3. The battery charger of the present invention includes a power output portion of a conductor wire which is stretchable received in the housing, and can be pulled out for using, very conveniently.
4. The battery charger of the present invention has a key ring fixing seat that can be used for carrying as a key ring.
5. The battery charger of the present invention has a decorative envelopment of various modeling, suitable for personal carring.

In conclusion, according to the above description and drawings disclosed herein surely can reach the expected objectives to provide a battery charger, which is new and useful.

The embodiments given are only for illustration, not limitation to the present invention. It will be obvious to those skilled in this art that various modifications or changes could be made without departing from the spirit of this invention.

1. A battery charger for a personal electronic device comprising:
a housing;
a battery energy storage unit provided in said housing;
a battery charging circuit provided in said housing, and electrically connected with said battery energy storage unit;
at least one power input portion electrically connected with said battery charging circuit to take power source for charging said battery energy storage unit;
an power converting circuit provided in said housing and electrically connected with said battery energy storage unit for converting power source; and
at least one power output portion electrically connected with said electric power converting circuit in order that said power of said battery energy storage unit electrically charges an electronic device through said power converting circuit and said power output portion.

2. The battery charger for a personal electronic device as in claim 1, wherein: said at least one power input portion includes a plug or a socket for connecting to an A.C. power socket.

3. The battery charger for a personal electronic device as in claim 1, wherein: said at least one power input portion includes a first D.C. socket for connecting with a D.C. power source.

4. The battery charger for a personal electronic device as in claim 1, wherein: said at least one power output portion includes an interface for connecting with a mobile phone and said interface is a conductor that is stretchably received in said housing.

5. The battery charger for a personal electronic device as in claim 1, wherein: said at least one power output portion includes a socket for connecting to miniature electronic devices by various interfaces respectively.

6. The battery charger for a personal electronic device as in claim 5, wherein: said miniature electronic devices include a mobile phone, a digital camera, an MP3 player and a PDA.

7. The battery charger for a personal electronic device as in claim 1, wherein said at least one power input portion includes a first D.C. socket for connecting with a D.C. power source, said at least one power output portion includes a second D.C. socket for connecting to miniature electronic devices, and the first D.C. socket and the second D.C. socket are positioned at a same hole on said housing.

8. The battery charger for a personal electronic device as in claim 1, wherein: said battery charger further includes an indicating lamp provided on said housing, and is electrically connected with said battery charging circuit or said electric power converting circuit.

9. The battery charger for a personal electronic device as in claim 1, wherein: said housing further has a key ring fixing seat.

10. The battery charger for a personal electronic device as in claim 1, wherein: said housing is enveloped by an envelopment
having a kind of modeling.

11. The battery charger for a personal electronic device as in claim 10, wherein: said envelopment is in the form of an animal.

12. The battery charger for a personal electronic device as in claim 10, wherein: said envelopment is provided with a key ring.

13. The battery charger for a personal electronic device as in claim 10, wherein: said envelopment is provided with a sealing means that is adapted to opening or sealing an opening, in order to take out or place into said battery charger through said opening.

14. The battery charger for a personal electronic device as in claim 13, wherein said sealing means is a zipper.

15. The battery charger for a personal electronic device as in claim 13, wherein said sealing means is a magic tape.

16. The battery charger for a personal electronic device as in claim 3, wherein: said first D.C. socket is able for connecting to a power source of cars by using a connecting line with a plug for a cigarette lighter's socket in the cars.
